(19) United States
(12) Patent Application Publication
(10) Pub. No.: US 2025/0271454 A1
(43) Pub. Date: Aug. 28, 2025

(54) SAMPLE HANDLERS OF DIAGNOSTIC LABORATORY ANALYZERS AND METHODS OF USE

(71) Applicant: Siemens Healthcare Diagnostics Inc., Tarrytown, NY (US)

(72) Inventors: Yao-Jen Chang, Princeton, NJ (US); Abhineet Kumar Pandey, Albany, NY (US); Nikhil Shenoy, West Windsor, NJ (US); Ramkrishna Jangale, Baner, Pune (IN); Benjamin S. Pollack; Ankur Kapoor, Plainsboro, NJ (US)

(73) Assignee: Siemens Healthcare Diagnostics Inc., Tarrytown, NY (US)

(21) Appl. No.: 18/858,591

(22) PCT Filed: May 17, 2023
(86) PCT No.: PCT/US2023/022596

§ 371 Date: Oct. 21, 2024

Related U.S. Application Data
(60) Provisional application No. 63/364,911, filed on May 18, 2022.

(51) Int. Cl. G01N 35/00; G06T 7/00; G06T 7/73; G06V 10/141; G06V 10/764

(52) U.S. Cl. CPC G01N 35/00732; G01N 35/0099; G06T 7/0004; G06T 7/73; G06V 10/141; G06V 10/764; G01N 2035/00831

(57) ABSTRACT

A sample handler of a diagnostic laboratory system includes a plurality of holding locations configured to receive sample containers. An imaging device is movable within the sample handler and is configured to capture images of the holding locations and sample containers received therein. A controller is configured to generate instructions that cause the imaging device to move within the sample handler and capture images. A classification algorithm is implemented in computer code, and includes a trained model configured to classify objects in the captured images. Other sample handlers and methods of handling sample containers are disclosed.

### CROSS REFERENCE TO RELATED APPLICATION

This application claims the benefit of U.S. Provisional Patent Application No. 63/364,911, entitled “SAMPLE HANDLERS OF DIAGNOSTIC LABORATORY ANALYZERS AND METHODS OF USE” filed May 18, 2022, the disclosure of which is hereby incorporated by reference in its entirety for all purposes.

### FIELD

Embodiments of the present disclosure relate to sample handlers of diagnostic laboratory analyzers and methods of using the sample handlers.

### BACKGROUND

Clinical diagnostic laboratory systems process patient samples such as blood, urine, or body tissue to test for various analytes. Samples are taken from patients and stored in sample containers, which are then delivered to laboratories housing the diagnostic systems. A laboratory system includes a sample handler that receives the sample containers. The sample containers are placed into trays, which are then loaded into the sample handler. A robot transfers the sample containers to and from carriers that transport the sample containers between instruments and other components within the laboratory system.

In order to accurately access and process the sample containers, the locations and types of sample containers in the trays need to be identified so the robot can locate and transport the sample containers throughout the laboratory system. As the processing time of laboratory systems decreases, the sample containers need to be identified and located faster. Thus, a need exists for sample handlers and methods of handling sample containers that quickly identify and locate sample containers.

### SUMMARY

According to a first aspect, a sample handler of a diagnostic laboratory system is provided. The sample handler includes a plurality of holding locations configured to receive sample containers; an imaging device movable within the sample handler configured to capture images of the holding locations and generate image data representative of the images; a controller configured to generate instructions that cause the imaging device to move within the sample handler and that cause the imaging device to capture images; and a classification algorithm implemented in computer code, the classification algorithm including a trained model configured to classify objects in the images.

In a further aspect, another sample handler of a diagnostic laboratory system is provided. The sample handler includes a plurality of holding locations configured to receive sample containers; a robot movable within the sample handler, the robot comprising a gripper configured to grip the sample containers to move the sample containers into and out of the holding locations; an imaging device affixed to the robot, the imaging device configured to capture images of the sample containers and generate image data representative of the images; a controller configured to generate instructions that cause the robot to move within the sample handler and to capture images using the imaging device; and a classification algorithm implemented in computer code, the classification algorithm including a trained model configured to identify the sample containers.

In another aspect, a method of operating a sample handler of a diagnostic laboratory system is provided. The method includes providing a plurality of holding locations within the sample handler, each of the plurality of holding locations configured to receive a sample container; providing a robot having a gripper configured to grip the sample containers and move the sample containers into and out of the plurality of holding locations; transporting an imaging device within the sample handler; capturing images of one or more of the sample containers; and classifying the images using a classification algorithm implemented in computer code, the classification algorithm including a trained model configured to identify the sample containers.

Still other aspects, features, and advantages of this disclosure may be readily apparent from the following description and illustration of a number of example embodiments, including the best mode contemplated for carrying out the disclosure. This disclosure may also be capable of other and different embodiments, and its several details may be modified in various respects, all without departing from the scope of the disclosure. This disclosure is intended to cover all modifications, equivalents, and alternatives falling within the scope of the claims and their equivalents.

### BRIEF DESCRIPTION OF THE DRAWINGS

The drawings, described below, are provided for illustrative purposes, and are not necessarily drawn to scale. Accordingly, the drawings and descriptions are to be regarded as illustrative in nature, and not as restrictive. The drawings are not intended to limit the scope of the disclosure in any way.

FIG. 1 illustrates a block diagram of a diagnostic laboratory system including a sample handler according to one or more embodiments.

FIG. 2 illustrates a top plan view of an interior of a sampler handler of a diagnostic laboratory system according to one or more embodiments.

FIG. 3 illustrates a perspective view of a robot in a sample handler of a diagnostic laboratory system coupled to a gantry that is configured to move the robot and an attached imaging device along x, y, and z axes according to one or more embodiments.

FIG. 4 illustrates a side elevation view of the robot of FIG. 3 wherein an imaging device is operative to capture an image of a sample container according to one or more embodiments.

FIG. 5 illustrates a flowchart of a method of operating a robot in a sample handler of a diagnostic laboratory system according to one or more embodiments.

FIG. 6 illustrates a flowchart of a method of identifying sample containers and operating a sample handler of a diagnostic laboratory system according to one or more embodiments.

FIG. 7 illustrates a side elevation view of the robot of FIG. 3 improperly gripping a sample container according to one or more embodiments.

FIG. 8 illustrates another side elevation view of the robot of FIG. 3 improperly gripping a sample container according to one or more embodiments.

FIG. 9 illustrates a top plan view of a sample handler of a diagnostic laboratory system with two spills and a misaligned tray according to one or more embodiments.

FIG. 10 illustrates a flowchart of a method of operating a sample handler of a diagnostic laboratory system according to one or more embodiments.

### DETAILED DESCRIPTION

Diagnostic laboratory systems conduct clinical chemistry and/or assays to identify analytes or other constituents in biological samples such as blood serum, blood plasma, urine, interstitial liquid, cerebrospinal liquids, and the like. The samples are collected in sample containers and then delivered to a diagnostic laboratory system. The sample containers are then loaded into trays, which are subsequently loaded into a sample handler of the laboratory system.

A robot within the sample handler is configured to grip the sample containers and transfer the sample containers to sample carriers that deliver the sample containers to specific locations, such as specific processing or analysis instruments in the laboratory system. The robot or controllers of the robot need to know the locations of the sample containers in the trays in order to grip the correct sample containers. In addition, the laboratory system may need to determine the types of sample containers stored in specific locations in the trays. For example, identification may determine whether the sample containers are capped, uncapped, or tube top sample cups. Identification may also determine the manufacturer of the sample containers and whether the sample containers have any chemicals located therein that are used during testing.

Accurately identifying the sample containers can be time consuming. For example, some sample handlers include at least one fixed imaging device at a fixed location that captures images of the sample containers while the sample containers are located in the sample handlers. These fixed cameras may have limited fields of view and may not be able to capture images of enough of the sample containers to accurately identify the sample containers. Some sample handlers overcome some of these issues with multiple fixed cameras. However, the multiple fixed cameras increase the costs of the sample handlers and increase the processing resources of the sample handlers.

The sample handlers described herein include imaging devices (e.g., a camera) movable within the sample handlers. In some embodiments, an imaging device is mounted to a robot that is movable within a sample handler. In some embodiments, the robot may be configured to move the sample containers within the sample handler. In other embodiments, another robot may be dedicated to moving the imaging device throughout the sample handler. As the imaging device is moved throughout the sample handler, the imaging device is able to capture images of the sample containers and other objects within the sample handler. The images may be used to identify, locate, and/or classify the sample containers and/or the other objects.

The robot may include a gripper configured to grip the sample containers. The imaging device may be affixed to the gripper to provide a view of the sample containers. In other embodiments, the imaging device may be affixed to a side of the robot, which enables the imaging device to capture images of the sample containers. In addition to classification that identifies the sample containers, the classification may determine whether the robot has properly gripped the sample containers. In some embodiments, the imaging device may be oriented to capture images in a downward direction, which enables the imaging device to capture tops or caps of the sample containers. This orientation also enables the imaging device to capture images of spills and other objects within the sample handler. The classification described herein may identify the spills and the other objects.

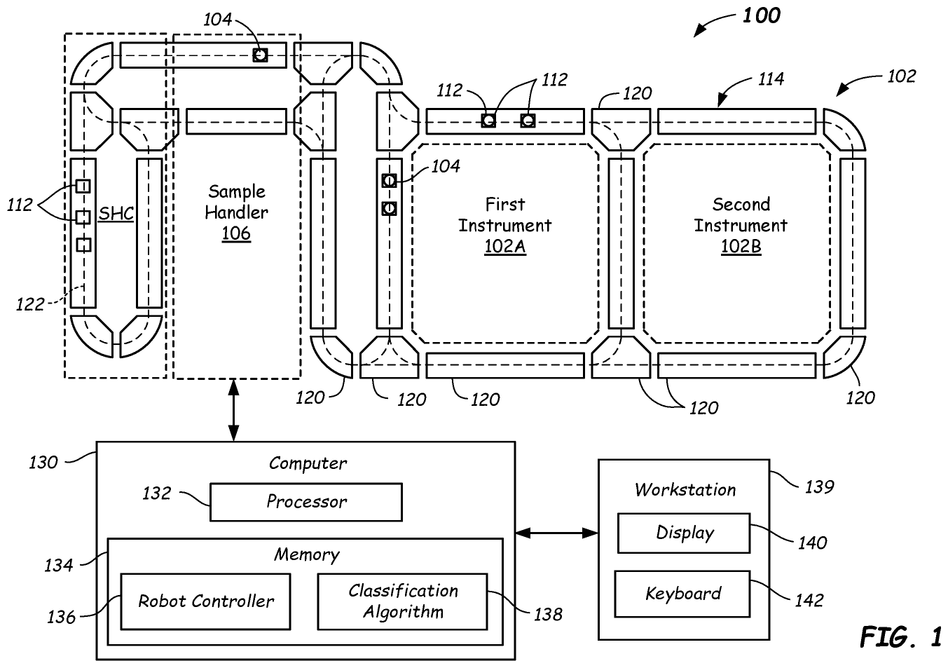

These and other sample handlers and methods of handling sample containers in laboratory systems are described in greater detail with reference to FIGS. 1-10.

Reference is now made to FIG. 1, which illustrates a block diagram of an embodiment of a diagnostic laboratory system 100. The laboratory system 100 may include a plurality of instruments 102 configured to process sample containers 104 (a few labelled) and to conduct assays or tests on samples located in the sample containers 104. The laboratory system 100 may have a first instrument 102A and a second instrument 102B. Other embodiments of the laboratory system 100 may include more or fewer instruments.

The samples located in the sample containers 104 may be various biological specimens collected from individuals, such as patients being evaluated by medical professionals. The samples may be collected from the patients and placed directly into the sample containers 104. The sample containers 104 may then be delivered to a laboratory or facility housing the laboratory system 100. As described in greater detail below, the sample containers 104 may be loaded into a sample handler 106, which may be an instrument of the laboratory system 100. From the sample handler 106, the sample containers 104 may be transferred into sample carriers 112 (a few labelled) that transport the sample containers 104 throughout the laboratory system 100, such as to the instruments 102, by way of a track 114.

The track 114 is configured to enable the sample carriers 112 to move throughout the laboratory system 100 including to and from the sample handler 106. For example, the track 114 may extend proximate or around at least some of the instruments 102 and the sample handler 106 as shown in FIG. 1. The instruments 102 and the sample handler 106 may have devices, such as robots (not shown in FIG. 1), that transfer the sample containers 104 to and from the sample carriers 112. The track 114 may include a plurality of segments 120 (a few labelled) that may be interconnected. The carriers 112 may move along the dashed lines 122 as shown in the segments 120. In some embodiments, some of the segments 120 may be integral with one or more of the instruments 102.

Components, such as the sample handler 106 and the instruments 102, of the laboratory system 100 may include or be coupled to a computer 130 configured to execute one or more programs that control the laboratory system 100 including components of the sample handler 106. The computer 130 may be configured to communicate with the instruments 102, the sample handler 106, and other components of the laboratory system 100. The computer 130 may include a processor 132 configured to execute programs including programs other than those described herein. The programs may be implemented in computer code.

The computer 130 may include or have access to memory 134 that may store one or more programs and/or data described herein. The memory 134 and/or programs stored therein may be referred to as a non-transitory computer-readable medium. The programs may be computer code executable on or by the processor 132. The memory 134 may include a robot controller 136 configured to generate instructions to control robots and/or similar devices in the instruments 102 and the sample handler 106. As described herein, the instructions generated by the robot controller 136 may be in response to data, such as image data received from the sample handler 106.

The memory 134 may also store a classification algorithm 138 that is configured to identify and/or classify the sample containers 104 and/or other items in the sample handler 106. In some embodiments, the classification algorithm 138 classifies object in the image data. The classification algorithm 138 may include a trained model, such as one or more neural networks. For example, the classification algorithm 138 may include a convolutional neural network (CNN) trained to identify objects in image data. The trained model is implemented using artificial intelligence (AI). Thus, the trained model may learn to classify objects. It is noted that the classification algorithm 138 is not a lookup table.

The computer 130 may be coupled to a workstation 139 that is configured to enable users to interface with the laboratory system 100. The workstation 139 may include a display 140, a keyboard 142, and other peripherals (not shown). Data generated by the computer 130 may be displayable on the display 140. The data may include warnings of anomalies detected by the classification algorithm 138. In addition, a user may enter data into the computer 130 by way of the workstation 139. The data entered by the user may be instructions causing the robot controller 136 or the classification algorithm 138 to perform certain operations.

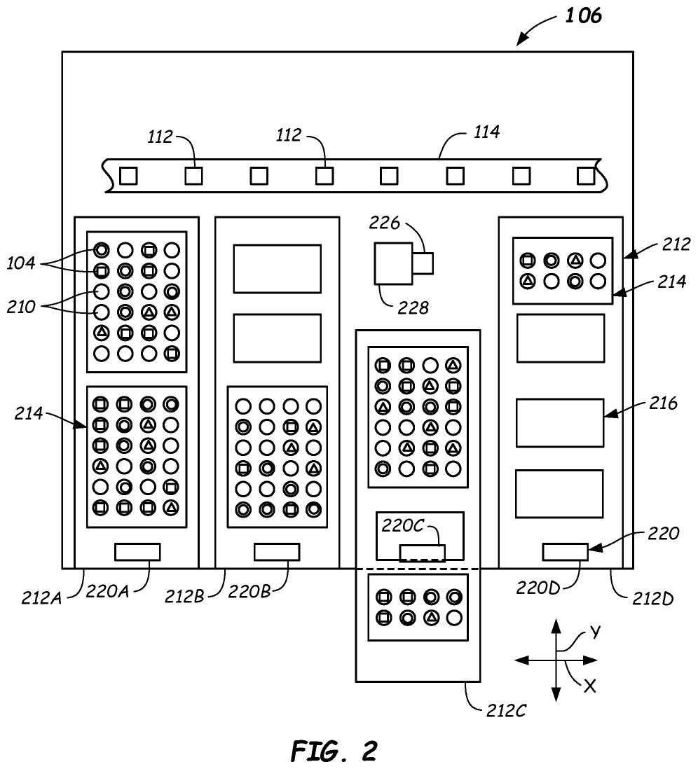

Additional reference is now made to FIG. 2, which illustrates a top plan view of the interior of the sample handler 106 according to one or more embodiments. The sample handler 106 is configured to capture images of the sample containers 104 and to move the sample containers 104 between holding locations 210 (a few labelled) and sample carriers 112. In the embodiment of FIG. 2, the holding locations 210 are located within trays 214 as described further below. The sample handler 106 may include a plurality of slides 212 that are configured to hold the trays 214. In some embodiments, the sample handler 106 may include four slides 212 that are referred to individually as a first slide 212A, a second slide 212B, a third slide 212C, and a fourth slide 212D. The third slide 212C is shown partially removed from the sample handler 106 which may occur during replacement of trays 214. Other embodiments of the sample handler 106 may include fewer or more slides than are shown in FIG. 2.

Each of the slides 212 may be configured to hold one or more trays 214. In the embodiment of FIG. 2, the slides 212 may include receivers 216 that are configured to receive the trays 214. Each of the trays 214 may contain a plurality of holding locations 210, wherein each holding location 210 is configured to receive one of the sample containers 104. In the embodiment of FIG. 2, the trays may vary in size to include large trays with twenty-four holding locations 210 and small trays with eight holding locations 210. Other configurations of the trays may include different numbers of holding locations 210.

In some embodiments, the sample handler 106 may include one or more slide sensors 220 that are configured to sense movement of one or more of the slides 212. The slide sensors 220 may generate signals indicative of slide movement, wherein the signals may be received and/or processed by the robot controller 136 as described herein. In the embodiment of FIG. 2, the sample handler 106 includes four slide sensors 220 arranged so that each of the slides 212 is associated with one of the slide sensors 220. A first slide sensor 220A senses movement of the first slide 212A, a second slide sensor 220B senses movement of the second slide 212B, a third slide sensor 220C senses movement of the third slide 212C, and a fourth slide sensor 220D senses movement of the fourth slide 212D. Various techniques may be employed by the slide sensors 220 to sense movement of the slides 212. In some embodiments, the slide sensor 220 may include mechanical switches that toggle when the slides 212 are moved. The toggling generates a signal indicating that a slide has moved. In other embodiments, the slide sensors 220 may generate optical signals in response to movement of the slides 212. In yet other embodiments, the slide sensors 220 may be imaging devices that generate image data as the slides 212 move.

The sample handler 106 includes an imaging device 226 that is movable throughout the sample handler 106. In the embodiment of FIG. 2, the imaging device is affixed to a robot 228 that is movable along an x-axis (e.g., in an x-direction) and a y-axis (e.g., in a y-direction) throughout the sample handler 106. In some embodiments, the imaging device 226 may be integral with the robot 228. In some embodiments, the robot 228 may be movable along a z-axis (e.g., in a z-direction), which is into and out of the page. In other embodiments, the robot 228 may include one or more components (not shown in FIG. 2) that move the imaging device 226 in the z-direction. In some embodiments, the robot 228 may receive movement instructions generated by the robot controller 136 (FIG. 1). The instructions may be data indicating x and y positions that the robot 228 should move to. In other embodiments, the instructions may be electrical signals that cause the robot 228 to move in the x-direction and the y-direction. The robot controller 136 may generate instructions to move the robot 228 in response to one or more of the slide sensors 220 detecting movement of one or more of the slides 212. The instructions may cause the robot 228 to move while the imaging device 226 captures images of newly-added sample containers.

The imaging device 226 includes one or more cameras that capture images, wherein capturing images generates image data representative of the images. The image data may be transmitted to the computer 130 to be processed by the classification algorithm 138 as described herein. The one or more cameras are configured to capture images of the sample containers 104 and/or other locations or objects in the sample handler 106. The images may be tops and/or sides of the sample containers 104. In some embodiments, the robot 228 may be a gripper robot that grips the sample containers 104 and moves the sample containers 104 between the holding locations 210 and the sample carriers 112. The images may be captured while the robot 228 is gripping the sample containers 104 as described herein.

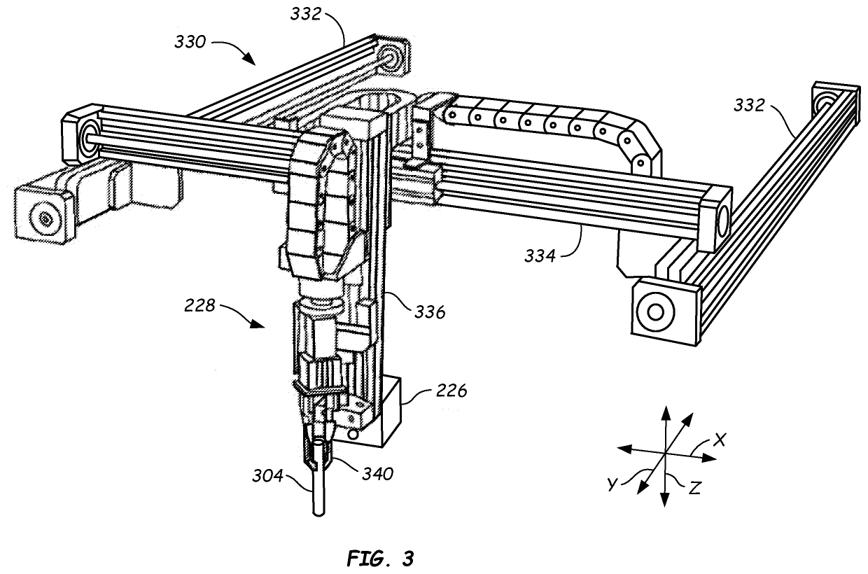

Additional reference is made to FIG. 3, which is a perspective view of an embodiment of the robot 228 coupled to a gantry 330 that is configured to move the robot 228 in the x-direction, the y-direction, and the z-direction. The gantry 330 may include two y-slides 332 that enable the robot 228 to move in the y-direction, an x-slide 334 that enables the robot 228 to move in the x-direction, and a z-slide 336 that enables the robot 228 to move in the z-direction. Movement in the three directions may be simultaneous and may be controlled by the robot controller 136. For example, the robot controller 136 may generate instructions that cause motors (not shown) coupled to the gantry 330 to move the slides in order to move the robot 228 and the imaging device 226 to predetermined locations.

The robot 228 may include a gripper 340 (e.g., end effector) configured to grip a sample container 304. The sample container 304 may be an example of a sample container 104. The robot 228 is moved to a position above a holding location and then moved in the z-direction to retrieve the sample container 304 from the holding location. The gripper 340 opens and the robot 228 moves down in the z-direction so that the gripper 340 extends over the sample container 304. The gripper 340 closes to grip the sample container 304 and the robot 228 moves up in the z-direction to extract the sample container 304 from the holding location. As shown in FIG. 3, the imaging device 226 may be affixed to the robot 228. The imaging device 226 includes at least one camera configured to capture images, wherein the captured images are converted to image data for processing such as by the classification algorithm 138.

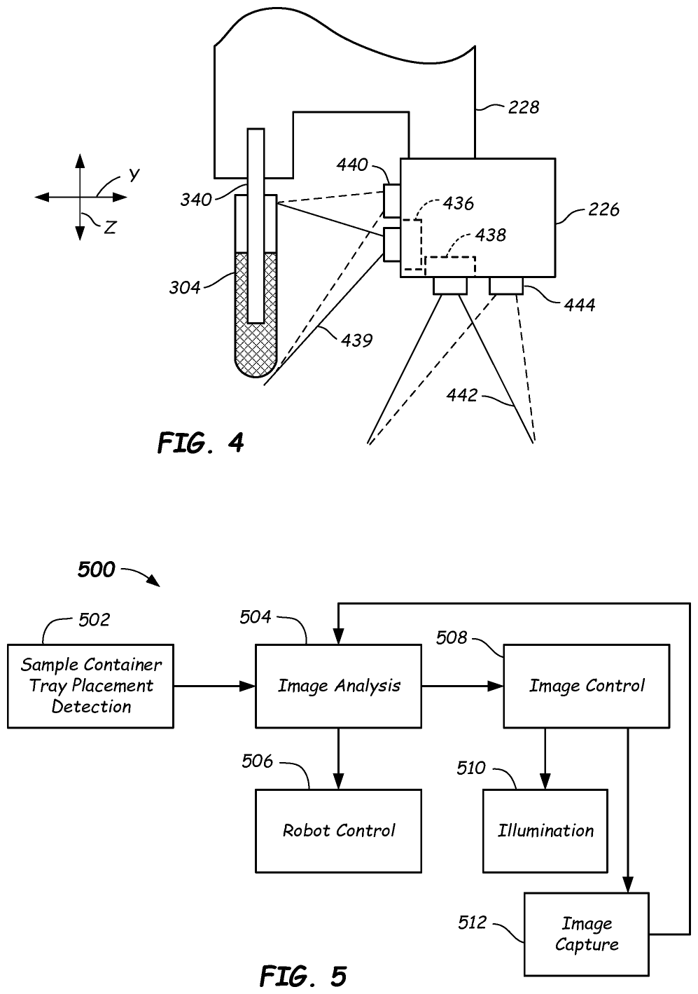

Additional reference is made to FIG. 4, which is a side elevation view of an embodiment of the robot 228 gripping a sample container 304 with the gripper 340 while the sample container 304 is being imaged by the imaging device 226. The imaging device 226 depicted in FIG. 4 may include a first camera 436 and a second camera 438. Other embodiments of the imaging device 226 may include a single camera or more than two cameras. The first camera 436 has a field of view 439 extending at least partially in the y-direction and may be configured to capture images of a sample container (e.g., sample container 304) being gripped by the gripper 340. An illumination source 440 may illuminate objects in the field of view 439. In some embodiments, the spectrum and intensity of light emitted by the illumination source 440 may be controlled by the classification algorithm 138. In other embodiments, the robot controller 136 (FIG. 1) is configured to control at least one of intensity of the illumination source 440 and a spectrum of light emitted by the illumination source 440.

The images captured by the first camera 436 may be analyzed by the classification algorithm 138 to determine characteristics of the sample container 304, the robot 228, and/or other components in the sample handler 106 as described herein. For example, the classification algorithm 138 may classify or identify the type of the sample container 304. The classification algorithm 138 may also determine whether the sample container 304 is being properly gripped by the gripper 340. In addition, the classification algorithm 138 may determine whether there are any anomalies in the sample handler 106 as described herein. Examples of the anomalies include spilled samples from one of the sample containers 104 (FIG. 2), misplaced sample containers 104, slides 212 that are incorrectly closed, and other problems.

The second camera 438 may have a field of view 442 that extends in the z-direction and may capture images of the trays 214, the sample containers 104 located in the trays 214, and other objects in the sample handler 106. An illumination source 444 may illuminate objects in the field of view 442. In some embodiments, the spectrum and intensity of light emitted by the illumination source 444 may be controlled by the classification algorithm 138. In other embodiments, the robot controller 136 (FIG. 1) is configured to control at least one of intensity of the illumination source 444 and a spectrum of light emitted by the illumination source 444. The field of view 442 enables images of the tops of the sample containers 104 to be captured as shown in FIG. 2. The captured images may be analyzed by the classification algorithm 138 (FIG. 1) to classify or identify the sample containers 104 and/or to determine whether any anomalies are present in the sample handler 106. In some embodiments, the imaging device 226 may have a single camera with a field of view that may capture at least a portion of the sample handler 106 and at least a portion of one of the trays 214.

In operation, a medical provider may order certain tests to be performed on samples collected from patients. The collected samples are placed in the sample containers 104. The sample containers 104 may be received in a laboratory or other facility where one or more of the trays 214 are located external to the sample handler 106. A laboratory technician (e.g., a user) places the sample containers 104 into the holding locations 210 of the trays 214.

Additional reference is now made to FIG. 5, which is a flowchart of a method 500 of operating the robot 228 and capturing images using the imaging device 226 according to one or more embodiments. When one or more of the holding locations 210 in one or more of the trays 214 has been filled with sample containers 104, the trays are placed onto one of the slides 212 and the slide is inserted into the sample handler 106. Processing then proceeds to tray placement detection 502 where receipt of the slide in the sample handler 106 is detected. In this example, the third slide 212C may have the above-described trays located thereon. When the third slide 212C is slid into the sample handler 106, the third slide sensor 220C detects movement of the third slide 212C and sends a signal to the computer 130. The robot controller 136 (FIG. 1) and/or the classification algorithm 138 may receive the signal.

In response to the signal, the robot controller 136 may generate instructions that cause the robot to move to one or more locations within the sample handler 106 so the imaging device 226 can capture one or more images of newly added sample containers. Thus, in some embodiments, the robot controller 136 is configured to generate instructions to move the imaging device 226 within the sample handler 106 and to capture one or more images in response to the signal. The instructions may cause the robot 228 to move in the z-direction away from the third slide 212C to enable the imaging device 226 to capture a wide-angle image of a plurality of newly added sample containers. The captured image may be analyzed at image analysis 504. Based on this analysis, the computer 130 may determine which ones of the holding locations 210 contain sample containers.

As described in greater detail herein, the robot controller 136, per image control 506, may move the imaging device 226 to specific locations relative to the third slide 212C. For example, the robot controller 136 may move the robot 228 to holding locations 210 that contain sample containers 104 so the imaging device 226 may capture images of these sample containers and the classification algorithm 138 may classify or identify the sample containers 104. Accordingly, the robot controller 136 may generate instructions that cause the robot 228 to move within the sample handler 106 to holding locations 210 in response to identifying the sample containers located in the holding locations 210.

Based on the image analysis 504, an image control 508 may set illumination via illumination 510 to capture subsequent images at image capture 512. In some embodiments, the intensity of the illumination may be adjusted per illumination 510. For example, if an image is dark, the image control 508 may instruct the illumination 510 to increase intensity during one or more subsequent image captures. The image control 508 may also instruct the illumination 510 to set certain spectrums of the illumination. The subsequently captured images may be analyzed by the image analysis 504, which may generate other image control and robot control instructions.

Several other embodiments of controlling the robot 228 and the imaging device 226 are described below. It is noted that in some embodiments, the imaging device 226 may be moved throughout the sample handler 106 by a transport system that is independent of the robot 228. Accordingly, in these embodiments, the imaging device 226 is not affixed to the robot 228. In other embodiments, the imaging device 226 may be affixed to a robot (not shown) that is dedicated to moving the imaging device 226 throughout the sample handler 106.

In some embodiments, one or more of the trays 214 may be dedicated to sample containers requiring high priority, which may be referred to as stat. For example, trays 214 having certain designations, such as imageable identification indicia or specific sizes (e.g., small ones of the trays 214) may be dedicated to stat sample containers. In other embodiments, trays loaded into a specific slide, such as the fourth slide 212D, may be designated as stat sample containers. The stat sample containers may be placed into a stat queue for priority classification by the classification algorithm 136 as described herein.

One of the methods of characterizing sample containers 104 that are newly loaded into the sample handler 106 is referred to as opportunistic scanning, which may minimize scan impact on cycle times of the sample handler 106. For example, opportunistic scanning may have minimal impact on the ability of the robot 228 to transfer the sample containers 104 into and out of the sample handler 106. In opportunistic scanning, the laboratory system 100 may process (e.g., image) the sample containers 104 using a dual queue first in/first out (FIFO) approach to scanning, where every sample container in the stat queue has priority over sample containers in a normal or non-stat queue. Therefore, newly added sample containers can only be time-sensitive (e.g., stat) if: (1) there are no sample containers in the stat queue and a tray containing stat sample containers was just loaded, or (2) there were no sample containers (stat or normal) of any kind previously loaded. The opportunistic scanning algorithm may only scan newly added sample containers and/or trays when the sample handler 106 does not have other tasks to perform, or one of condition (1) or condition (2) are met.

The opportunistic scanning can be further optimized if the holding locations 210 occupied by sample containers 104 are known. Determining which ones of the holding locations 210 are occupied can be achieved by using a stationary wide field of view camera mounted at a distant vantage point, performing a fast and rough scanning of newly inserted trays, or positioning the imaging device 226 at a high position to get a large field of view. Depending on the field of view of the imaging device 226 and sample container distribution in the trays 214, the robot controller 136 (FIG. 1) can determine an optimal path for guiding the robot 228 to image the sample containers 104 or other objects. The stationary wide field of view imaging device may be implemented in one or more of the slide sensors 220. The fast and rough scanning of the newly inserted trays may be performed as described above upon one of the slide sensors 220 detecting insertion or movement of respective ones of the slides 212.

Another method of scanning is referred to as the improved confidence scanning algorithm and may resolve inconsistent characterization. For example, the classification algorithm 138 may determine that characterization of one or more of the sample containers 104 or other objects (e.g., spills) are not correct or have low classification confidence. The algorithm may schedule extra scan paths with the imaging device 226 to capture additional images of sample containers 104 that have low classification confidence as may be determined by the classification algorithm 138. The additional images can vary the illumination intensity or spectrum, such as by the illumination 510 (FIG. 1). In addition, the additional images may be captured using different positions of the robot 228 and/or the imaging device 226. In other embodiments, a scan speed of the imaging device 226 during image capturing can be changed (e.g., slowed) to improve the robustness of the sample container characterization. This algorithm may be implemented with a closed loop system triggered by another vision system that disagrees with the sample container characterization.

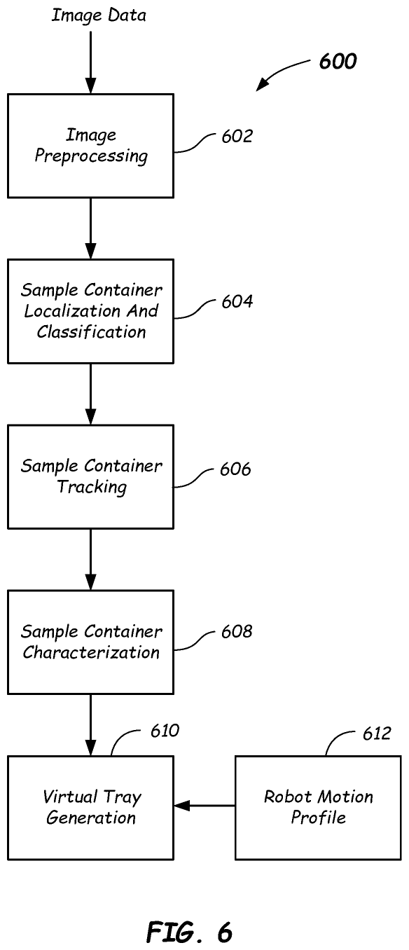

Additional reference is made to FIG. 6, which is a flowchart illustrating the image analysis 504 in conjunction with the classification algorithm 138. Image data may be received at operation block 602 where preprocessing such as deblur, gamma correction, and radial distortion correction may be performed before further processing. The preprocessing performed at operational block 602 may be performed in conjunction with or using algorithms in the image analysis 504 of FIG. 5. The image data may be captured using one or both of the first camera 436 and the second camera 438. Thus, the images may include the tops of the sample containers 104 and/or the sample container 304 being gripped by the gripper 340.

Processing may proceed to a sample container localization and classification at operational block 604 where the images of the sample containers 104 may undergo localization and classification. Localization may include surrounding images of sample containers or other objects with a virtual box (e.g., a bounding box) to isolate the sample containers 104 and other objects for classification. Classification may be performed using a data-driven machine-learning based approach such as a convolutional neural network (CNN). The CNN may be enhanced using YOLOv4 or other image identification networks or models.

YOLOv4 is a real-time object detection model that works by breaking the object detection task into two pieces, using regression to identify object positioning via bounding boxes and classification to determine the class of the object. The localization provides a bounding box for each detected sample container or object. The classification determines high level characteristics of the sample container such as whether there is a sample container or not in holding locations 210 of the trays 214. High level characteristics may also include determining whether the sample containers 104 are capped, uncapped, or tube top sample cups (TTSC) in addition to classification confidence.

An example of the high level characteristics is illustrated in FIG. 2. As shown, some of the holding locations 210 are displayed with either circles, triangles, squares, or empty. The circles may represent sample containers that are uncapped, squares may represent sample containers that are capped, and triangles may represent tube top sample cups. Holding locations without circles, square, or triangles represent empty holding locations.

Processing may proceed to sample container tracking at operational block 606 where, for each newly detected sample container, the computer 130 (e.g., the robot controller 136 or the classification algorithm 138) may assign a new tracklet identification to each sample container. Alternatively, the computer 130 may try to associate a detected sample container with an existing tracklet established in previous images based on an overlapping area between a detected bounding box and a predicted bounding box established on the motion trajectory, classification confidence, and other features derived from the appearance of the image of the sample container. In situations where detections are potentially missed, which prevents tracking, a more sophisticated data association algorithm such as the Hungarian algorithm may be utilized to ensure robustness of the tracking.

When a tracklet contains sufficient observations collected across multiple images (e.g., frames), the classification algorithm 138 may start to estimate more detailed characteristics per operational block 608. The characteristics include, but are not limited to, sample container height and diameter, color of a cap, shape of a cap, and barcode reading when a bar code is in a field of view of the imaging device 226. Because the sample containers 104 do not change their positions within the trays 214, each tracklet can be mapped to a virtual tray location while maintaining the relative position with respect to other tracklets per operational block 610. With positioning information and motion profiles in operational block 612 obtained by the robot controller 136, each tracklet may be associated to its physical position in the trays 214.

In some embodiments, the processing in the sample handler 106 may be able to utilize the sample container characterization information and image information to implement other operations of the sample handler 106. For example, the imaging device 226 is moveable and can monitor each sample container that is in the field of view 439 (FIG. 4) of the first camera 436 and/or the field of view 442 of the second camera 438. In such situations, the image data may be processed by the computer 130 to verify pickup and placement operations of the sample containers 104 when the gripper 340 (FIG. 4) interacts with the sample containers 104.

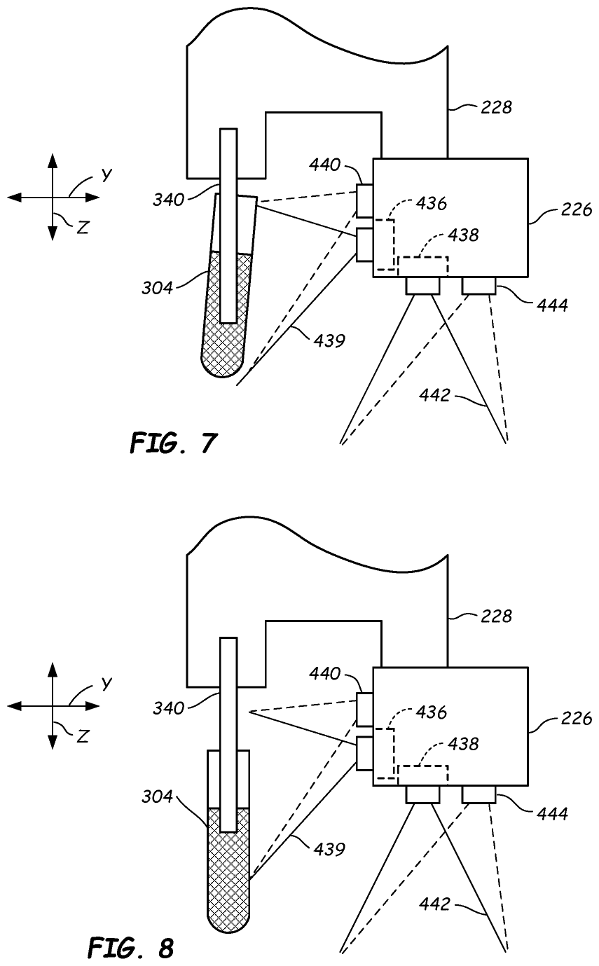

Additional reference is made to FIG. 7, which illustrates the robot 228 improperly gripping the sample container 304. As shown in FIG. 7, the sample container 304 is askew relative to the gripper 340. The imaging device 226, such as the first camera 436, captures images of the sample container 304 after being illuminated by the illumination source 440. The image data may be processed per the method 600 of FIG. 6 and analyzed by the classification algorithm 138. AI and/or deep learning neural networks in the classification algorithm 138 may have been trained to recognize aligned and misaligned sample containers 104 relative to the gripper 340. Based on the analysis, the computer 130 may determine that the sample container 304 is misaligned relative to the gripper 340. The computer 130 may then notify a user of the misalignment, such as by transmitting a notice via the workstation 139. In some embodiments, the computer 130 may execute one or more programs, such as the robot controller 136 to fix the misaligned sample container 304.

Additional reference is made to FIG. 8, which illustrates another example of the robot 228 mishandling the sample container 304. In the embodiment of FIG. 8, the gripper 340 has gripped the sample container 304 at a too high position. The AI and/or deep learning neural networks of the classification algorithm 138 may be trained to recognize situations in which the sample container 304 is too low relative to the gripper 340. In other embodiments, the AI and/or networks may be trained to recognize properly aligned sample containers relative to the gripper 340. If the sample container 304 is not found to be properly aligned, the computer 130 may assume that the improper alignment is caused by the gripper 340. A notice of the misalignment may then be sent to the user such as via the workstation 139.

In addition to the foregoing, the imaging device 226 may capture images of other items or locations in the sample handler 106. One or more of the cameras in the imaging device 226 may be configured to capture images at one or more vantage points that enable surveillance of a large portion of the sample handler 106. For example, the imaging device 226 may be raised high in the z-direction so that the second camera 438 (FIG. 4) may capture images of large portions of the sample handler 106 including, for example, large portions of the trays 214. By analyzing the images, such as by using the classification algorithm 138, the robot controller 136 may generate instructions to guide the robot 228 and the imaging device 226 to the specific area for detailed sample container characterization or accident verification and recovery when necessary.

In cases of extreme misalignment of a sample container by the gripper 340 or in cases of the gripper 340 dropping a sample container, the imaging device 226 in conjunction with the classification algorithm 138 may detect these situations. The workstation 139 may then notify a user. A sample container that is dropped or encounters other sample handling anomalies can spill biohazardous liquids in the sample handler 106, on the track 114, or on one of the sample carriers 112, which may cause the biohazardous liquids to be spread throughout the laboratory system 100.

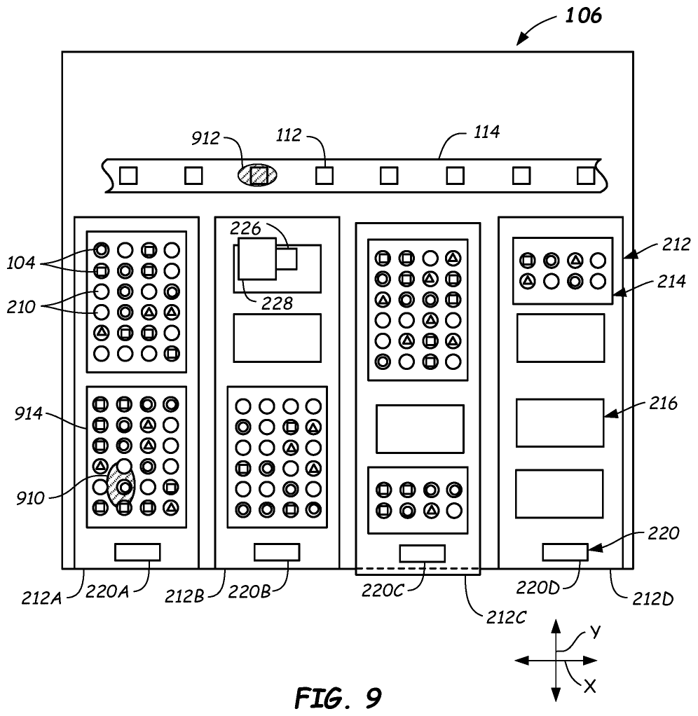

Additional reference is made to FIG. 9, which illustrates the sample handler 106 with a first spill 910 and a second spill 912. In some embodiments, the imaging device 226 may capture images of the first spill 910 and the second spill 912. By imaging a large area of the sample handler 106, the imaging device 226 may capture images of the suspected spills. The classification algorithm 138 may be trained to identify spilled liquids in the image data such as the first spill 910 and the second spill 912. The robot controller 136 may generate instructions to move the imaging device 226 proximate a suspected spill to capture more images to verify that a spill occurred and to identify the exact location of the spill. The user may then be notified of the spill.

In the embodiment of FIG. 9, the first spill 910 is located on a tray 914. When the imaging device 226 is located above the first spill 910, the second camera 438 may capture images of the first spill 910. The robot controller 136 may then generate instructions to move the imaging device 226 proximate the first spill 910 so the imaging device 226 may capture additional close-up images of the first spill 910. In some embodiments, the classification algorithm 138 may use AI, such as a model or CNN, to determine the liquids in the first spill 910. The second spill 912 is located on a carrier and could spread throughout the laboratory system 100 if the second spill 912 is unattended. The second spill 912 may be identified and/or classified using processes similar to processes used to identify the first spill 910.

In addition to the foregoing, the imaging device 226 in conjunction with the computer 130 may be used to determine whether the slides 212 are closed properly. As shown in FIG. 9, the third slide 212C is partially open, which in conventional sample handlers may cause the gripper 340 (FIG. 3) to improperly grip the sample containers 104. The imaging device 226 may be moved to locations where holding locations 210 are expected to be located if the third slide 212C is properly closed. In some embodiments, the classification algorithm 138 may identify the holding locations 210 in captured images and determine whether the holding locations 210 are in predetermined locations. If the holding locations 210 are not in the predetermined locations, the computer 130 may determine that the third slide 212C is not closed properly. The user may be notified by way of the workstation 139 that the third slide 212C is open. In other embodiments, the computer 130 may use the locations of the holding locations 210 to calibrate the robot controller 136 with actual locations of the holding locations 210.

In some embodiments, the classification algorithm 138 may be trained to identify dropped sample containers. A dropped sample container may appear horizontal in the images and may be identified (e.g., classified) as such by the classification algorithm 138. If a horizontal sample container is identified, the computer 130 may commence one or more algorithms configured to determine if a spill is also present proximate the horizontal sample container. The horizontal sample container may block access to one or more of the holding locations 210 proximate the horizontal sample container. In response, the robot controller 136 may divert the robot 228 around the horizontal sample container. The user may also be notified of the dropped sample container.

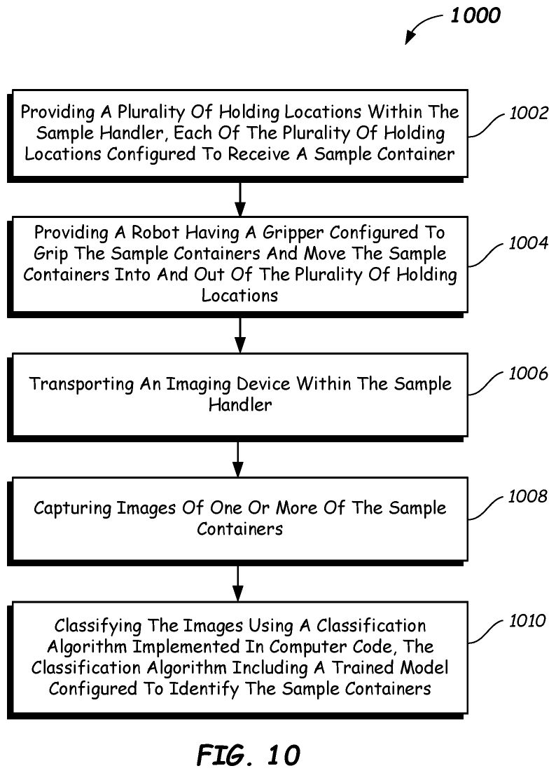

Reference is made to FIG. 10, which is a flowchart illustrating a method 1000 of operating a sample handler (e.g., sample handler 106) of a diagnostic laboratory system (e.g., laboratory system 100). The method 1000 includes, at process block 1102, providing a plurality of holding locations (e.g., holding locations 210) within the sample handler, each of the plurality of holding locations configured to receive a sample container (e.g., sample containers 104). The method 1000 includes, at process block 1004, providing a robot (e.g., robot 228) having a gripper (e.g., gripper 340) configured to grip the sample containers and move the sample containers into and out of the plurality of holding locations. The method 1000 includes, at process block 1006, transporting an imaging device (e.g., imaging device 226) within the sample handler. The method 1000 includes, at process block 1008, capturing images of one or more of the sample containers. The method 1000 includes, at process block 1010, classifying the images using a classification algorithm (e.g., classification algorithm 138) implemented in computer code, the classification algorithm including a trained model configured to identify the sample containers.

While the disclosure is susceptible to various modifications and alternative forms, specific method and apparatus embodiments have been shown by way of example in the drawings and are described in detail herein. It should be understood, however, that the particular methods and apparatus disclosed herein are not intended to limit the disclosure but, to the contrary, to cover all modifications, equivalents, and alternatives falling within the scope of the claims.

What is claimed is:

1. A sample handler of a diagnostic laboratory system, comprising:
a plurality of holding locations configured to receive sample containers;
an imaging device movable within the sample handler configured to capture images of the holding locations and generate image data representative of the images;
a controller configured to generate instructions that cause the imaging device to move within the sample handler and that cause the imaging device to capture images; and
a classification algorithm implemented in computer code, the classification algorithm including a trained model configured to classify objects in the images.

2. The sample handler of claim 1, wherein the classification algorithm is configured to identify the sample containers as being at least capped, uncapped, and tube top sample cups.

3. The sample handler of claim 1, wherein the classification algorithm is configured to classify at least one of:
color of a cap of a sample container;
shape of a cap of a sample container; and
identification indicia on a sample container.

4. The sample handler of claim 1, wherein the classification algorithm is configured to identify a position of a sample container relative to at least one of:
a holding location;
a gripper of a robot configured to move the sample containers in the sample handler; and
a sample carrier.

5. The sample handler of claim 1, further comprising a sensor configured to detect movement of one or more of the holding locations and to generate a signal in response to the movement, wherein the controller is configured to generate instructions to move the imaging device within the sample handler and to capture images in response to the signal.

6. The sample handler of claim 1, further comprising an illumination source movable within the sample handler and configured to illuminate objects.

7. The sample handler of claim 6, wherein the controller is configured to control at least one of intensity of the illumination and a spectrum of the illumination.

8. The sample handler of claim 1, wherein the controller configured to:
generate instructions that cause the imaging device to move within the sample handler and that cause the imaging device to capture images of sample containers;
identify positions of one or more sample containers by analyzing the captured images; and
move the imaging device to the positions of the one or more sample containers.

9. The sample handler of claim 1, wherein the classification algorithm is configured to identify a misplaced sample container.

10. The sample handler of claim 1, wherein the classification algorithm is configured identify a spilled liquid in the sample handler.

11. The sample handler of claim 1, further comprising a robot configured to move within the sample handler, wherein the imaging device is affixed to the robot, and wherein the controller generates instructions that cause the robot to move within the sample handler.

12. The sample handler of claim 11, further comprising a fixed camera in a fixed location within the sample handler, wherein the controller is configured to:
capture images of holding locations using the fixed camera;
analyze the images to identify locations of the holding locations; and
generate instructions that cause the robot to move within the sample handler to holding locations in response to identifying the locations of the holding locations.

13. The sample handler of claim 11, wherein the robot comprises a gripper configured to grip the sample containers.

14. The sample handler of claim 13, wherein the imaging device is configured to capture images of the gripper gripping a sample container.

15. The sample handler of claim 14 wherein the classification algorithm is configured to identify one or more anomalies in the gripping of the sample container.

16. A sample handler of a diagnostic laboratory system, comprising:
a plurality of holding locations configured to receive sample containers;
a robot movable within the sample handler, the robot comprising a gripper configured to grip the sample containers to move the sample containers into and out of the holding locations;
an imaging device affixed to the robot, the imaging device configured to capture images of the sample containers and generate image data representative of the images;
a controller configured to generate instructions that cause the robot to move within the sample handler and to capture images using the imaging device; and
a classification algorithm implemented in computer code, the classification algorithm including a trained model configured to identify the sample containers.

17. The sample handler of claim 16, wherein the imaging device is configured to capture images of spilled liquid in the sample handler and wherein the classification algorithm is trained to identify the spilled liquid.

18. The sample handler of claim 16, wherein the imaging device is configured to capture images of the sample containers while gripped by the gripper and wherein the classification algorithm is trained to identify anomalies between the gripper and the sample containers.

19. The sample handler of claim 16, wherein the classification algorithm is trained to identify misplaced sample containers.

20. A method of operating a sample handler of a diagnostic laboratory system, the method comprising:
providing a plurality of holding locations within the sample handler, each of the plurality of holding locations configured to receive a sample container;
providing a robot having a gripper configured to grip sample containers and move the sample containers into and out of the plurality of holding locations;
transporting an imaging device within the sample handler;
capturing images of one or more of the sample containers; and
classifying the images using a classification algorithm implemented in computer code, the classification algorithm including a trained model configured to identify the sample containers.

21. The method of claim 20, wherein the classifying comprises identifying spilled liquid in the sample handler.

22. The method of claim 20, wherein the classifying comprises identifying anomalies in the gripping between the gripper and the sample containers.

23. The method of claim 20, wherein the classifying comprises identifying misplaced sample containers.
